(19) United States
(12) Patent Application Publication
(10) Pub. No.: US 2023/0260775 A1
(43) Pub. Date: Aug. 17, 2023

(54) Electron Activation Dissociation Reaction Device with Ion Isolation Functionality in Mass Spectrometry

(71) Applicant: DH Technologies Development Pte. Ltd., Singapore (SG)

(72) Inventors: Takashi BABA, Richmond Hill (CA); Grant GODBEHERE, Port Perry (CA)

(21) Appl. No.: 18/016,173

(22) PCT Filed: Jul. 12, 2021
(86) PCT No.: PCT/IB2021/056257

§ 371 Date: Jan. 13, 2023

Related U.S. Application Data
(60) Provisional application No. 63/051,683, filed on Jul. 14, 2020.

(51) Int. Cl. H01J 49/42; H01J 49/40

(52) U.S. Cl. CPC H01J 49/422; H01J 49/427; H01J 49/421; H01J 49/40

(57) ABSTRACT

In one aspect, a method of performing mass spectrometry is disclosed, which comprises ionizing a sample to generate a plurality of precursor ions, passing the precursor ions through a mass filter to select at least one subset of the ions, introducing the selected ions into a branched radiofrequency (RF) ion trap and subjecting at least a portion of said selected precursor ions to fragmentation within the ion trap so as to generate a first plurality of fragment ions. The method can further include isolating at least a portion of the first plurality of fragment ions in at least one branch of the branched RF ion trap, removing unwanted fragment ions, releasing the remaining ions from said at least one branch and subjecting at least a portion thereof to fragmentation so as to generate a second plurality of fragment ions. Any combination of collision induced dissociation (CID) and electron activation dissociation (EAD) can be employed for fragmenting the ions.

### RELATED APPLICATION

This application claims priority to U.S. provisional application No. 63/051,683 filed on Jul. 14, 2020, entitled “Electron Activation Dissociation Reaction Device with Ion Isolation Functionality in Mass Spectrometry,” which is incorporated herein by reference in its entirety.

### FIELD

The present teachings are generally related to ion dissociation devices, which can be incorporated in a mass spectrometer to provide tandem MS(n) analysis of analytes.

### BACKGROUND

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

Some mass spectrometers include an ion reaction device, such as a collision induced dissociation device (CID device) and an electron capture dissociation device (ECD device), that can be employed to cause fragmentation of ions to allow obtaining additional structural information regarding ions under investigation. An ECD device with the best performance is composed of non-quadrupole RF ion trap or branched RF ion trap (U.S. Pat. No. 10,014,166B2), however, such a device suffers from a number of shortcomings. For example, the ECD devices allow only tandem mass spectrometry (MS/MS) workflow.

Accordingly, there is a need for improved ion reaction devices for use in mass spectrometry and methods of performing multiple tandem mass spectrometry (MSⁿ) using such devices.

### SUMMARY

In one aspect, a method of performing mass spectrometry is disclosed, which comprises ionizing a sample to generate a plurality of precursor ions, passing the precursor ions through a mass filter to select at least one subset of the ions, introducing the selected ions into a branched radiofrequency (RF) ion trap and subjecting at least a portion of said selected precursor ions to fragmentation within the ion trap by ECD or CID so as to generate a first plurality of fragment ions. The method can further include isolating at least a portion of the first plurality of fragment ions, releasing the first plurality of fragment ions (or at least a portion thereof) into an interaction region of the ion trap and subjecting at least a portion thereof to fragmentation so as to generate a second plurality of fragment ions. The branched RF ion trap can include an axial section having a trap center and four branches extending transversely from the trap center.

The step of isolating at least a portion of the first plurality of fragment ions can include causing said at least a portion of the first plurality of fragment ions to enter at least one, and typically two, branches of the branched RF ion trap. For example, a DC voltage can be applied to an isolation electrode positioned in proximity of those transverse branches to cause at least a portion of the first plurality of fragment ions to enter at least one of those branches. In some embodiments, the isolation electrode extends from the proximal end to the distal end of the axial section.

In some embodiments, a resolving DC voltage can be applied to at least one of the transverse branches in which the fragment ions are trapped so as to remove unwanted fragment ions (e.g., fragment ions having m/z ratios outside of a predefined stability range of wanted fragment ions) from the trapped fragment ions. The ions remaining trapped within the transverse branch(es) can then be released by adjusting the DC voltage applied to an isolation electrode. The released ions can undergo the second fragmentation in vicinity of the trap center of the RF ion trap.

In some embodiments, the precursor ions are fragmented using any of collision induced dissociation (CID) and electron capture dissociation (ECD). Further, in some embodiments, the first plurality of fragment ions are further fragmented using any of CID and ECD.

In some embodiments, any of the precursor ions and the first plurality of fragment ions are dissociated via electron activation dissociation (EAD) using an electron beam having an energy in a range of about 0 eV to about 50 eV. EAD includes ECD, hot ECD, electron ionization dissociation, electron induced dissociation, electron impact excitation of ions from Organics (EIEIO), negative ion Electron capture dissociation (niECD), and electron detachment dissociation (EDD)

The second plurality of fragment ions can be passed through any type of mass analyzer to generate a mass spectrum thereof. In some embodiments, the mass analyzer can be a time-of-flight (ToF) mass analyzer.

In a related aspect, a mass spectrometer is disclosed, which comprises an ion reaction device, a branched radiofrequency (RF) ion trap comprising eight L-shaped rods positioned axially at a distance relative to one another so as to provide an axial section characterized by a central axis for receiving and extracting ions from an ion source and two branched sections extending transversely from a central portion of said axial section and characterized by a transverse axis for receiving electrons from an electron source. The mass spectrometer further includes a source for generating electrons such that the electrons enter the ion reaction device along the transverse axis of the ion trap to interact with ions received along the central axis in vicinity of the central portion of said axial section so as to cause fragmentation of at least a portion of the ions to generate a first set of fragment ions. In some embodiments, a magnetic field is applied along the transverse axis to help direct electrons received via the transverse axis to the center of the trap. An isolation electrode is positioned in vicinity of the branched sections for causing transfer of at least a portion of the first set of fragment ions from the central portion to at least one of said branched sections and isolating the ions transferred to said at least one of said branched sections. Further, a DC voltage source is provided for applying a DC voltage to at least one of said L-shaped rods for removing unwanted ions from the set of fragment ions isolated in at least one of the transverse branched section. The remaining fragment ions can be release from the branched section by lowering the DC voltage applied to the isolation electrode. The mass spectrometer can further include a gas introduction system (not shown) for introducing a gas into the ion reaction device. In some embodiments, the gas can be any of helium, nitrogen, or neon. In some embodiments, the gas can include one or more reactive molecules, such as oxygen. The typical pressure of the gas inside the ion reaction device can be a few mTorr, e.g., in a range of about 1 to about 10 mTorr.

Another DC voltage source can be provided for applying a DC voltage to the isolation electrode to cause transfer of said at least a portion of said first set of fragment ions into said at least one of the branched transverse sections.

The mass spectrometer can further include an RF voltage source for applying an RF voltage to the L-shaped rods for radially confining the precursor ions and the fragment ions.

A mass analyzer can be disposed downstream of the ion reaction device to receive the second plurality of fragment ions and to generate a mass spectrum thereof. In some embodiments, the mass analyzer can be a time-of-flight (ToF) mass analyzer.

### BRIEF DESCRIPTION OF THE DRAWINGS

FIGS. 1A and 1B schematically depict an ion reaction device according to an embodiment of the present teachings,

FIG. 2 schematically depicts an ion reaction device operating in a conventional manner,

FIG. 3 schematically shows the isolation of fragment ions in transverse branches of an ion reaction device according to an embodiment of the present teachings,

FIG. 4A is another schematic view of an ion reaction device operating in a conventional manner,

FIG. 4B shows islands of stability and instability for an ion having an m/z=609 trapped in the ion reaction device depicted in FIG. 4A as a function of applied RF confinement and DC resolving voltages,

FIG. 5A is a schematic view of an ion reaction device according to an embodiment of the present teachings,

FIG. 5B shows islands of stability and instability for an ion having an m/z=609 trapped in the ion reaction device depicted in FIG. 5A as a function of applied RF confinement and DC resolving voltages, illustrating a region of stability for certain values of the RF and DC voltages,

FIG. 6 schematically shows a mass spectrometer in which an ion reaction device according to an embodiment of the present teachings is incorporated,

FIG. 7A shows the mass spectrum of a pair of isomeric glycopeptides separated via liquid chromatography,

FIG. 7B shows the mass spectrum of the isolated glycopeptides without any dissociation,

FIG. 7C shows the mass spectrum of the CID products of the isolated glycopeptides,

FIG. 7D shows the mass spectrum of an isolated CID products having an m/z of 557,

FIG. 7E shows fragments of the isolated glycopeptide observed via MS(3) workflow in which CID and EIEIO were employed for ion fragmentation,

FIGS. 8A and 8B show the chemical structures of a pair of isomeric glycopeptides with different sialic acid linkages,

FIG. 9 shows a CID-EIEIO spectrum of a standard that is verified to have alpha (2,3) linkage in tryptic digest of a protein, fetuin from bovine,

FIG. 10 shows another CID-EIEO spectrum of a standard that is verified to have alpha (2,6) linkage,

FIG. 11 shows identification of an unknown linkage of sialic acid in a glycopeptide contained in hen's egg yolk,

FIG. 12A schematically depicts a plurality of fragment ions at the center of the RF ion trap,

FIG. 12B schematically depicts that the application of a DC voltage to T-bar electrode can cause the transfer of the fragment ions from the center of the RF ion trap to the transverse branches,

FIG. 12C schematically depicts removing unwanted fragment ions from the set of the fragment ions isolated in the transverse branches via application of a resolving DC voltage to the L-shaped rods,

FIG. 12D schematically depicts that following the removal of the unwanted fragment ions, the other ions remain trapped in the transverse branches, and

FIG. 12E schematically depicts the removal of the remaining fragment ions from the transverse branches into the trap center via lowering a DC voltage applied to the T-shaped isolation electrode.

### DETAILED DESCRIPTION

The present teachings generally provide an RF ion reaction device that can be used to cause multiple fragmentations of precursor ions. In other words, an RF ion reaction device according to the present teachings allows performing multiple tandem mass spectrometry, i.e., MS(n), which can in turn allow deeper understanding of molecular structures under investigation. For example, the systems and methods disclosed herein can be employed for identification of sialic acid linkages in glycans.

Various terms are used herein in accordance with their ordinary meanings in the art. The term “about” as used herein is intended to indicate a variation of at most 5 percent.

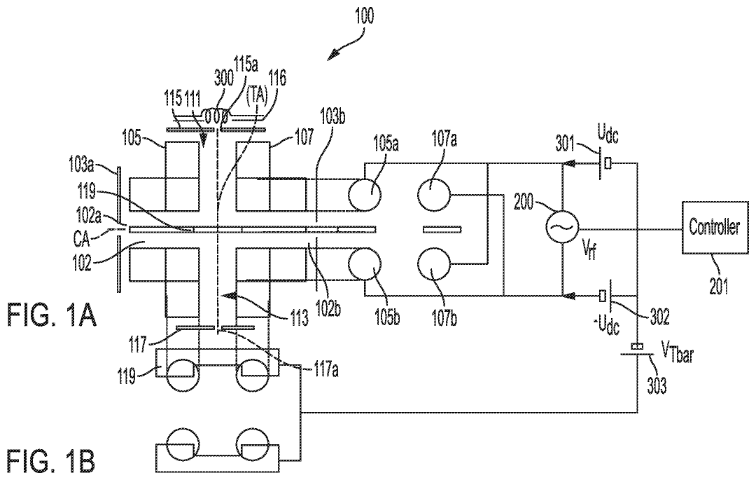

With reference to FIGS. 1A and 1B, an ion reaction device 100 according to an embodiment of the present teachings that includes an axial pathway 102 extending from a proximal end 102a, which provides an entrance port through which ions generated by an upstream ion source (not shown in this figure) can enter the ion reaction device, to a distal end 102b, which provides an exit port through which ions can leave the ion reaction device, along a central axis (CA). In proximity of the proximal and distal ends 102a and 102b, electrode gates 103a/103b are, respectively, situated, which allow for the control of entrance and ejection of the ions from the ion reaction device substantially along the central axis (CA).

The ion reaction device 100 further includes a first set of electrodes 105, which are generally L-shaped, and are arranged around the central axis (CA). In the figures, only two of the four electrodes of the first set are shown. The other two electrodes are situated directly behind the L-shaped rods that are depicted.

A second set of electrodes 107 (two of which are depicted, and the other two are directly behind the depicted electrodes) is situated at a slight axial distance to make a quadrupole configuration relative to the first set of electrodes in the direction of electron beam path (TA).

The arrangement of the two sets of the L-shaped electrodes 105/107 relative to one another provides, in addition to the axial pathway 102, two transverse branches 111/113 characterized by a transverse axis (TA). Two electrodes 115/116 positioned at each end of the transverse axis (TA) can help trap ions (e.g., ion fragments generated by fragmentation of a plurality of precursor ions, as discussed in more detail below) within the two transverse branches. In this embodiment, the two electrodes 115/117 include openings 115a/117a. In this embodiment, a filament 118 is positioned in proximity of a gate electrode 116, where the filament can be heated to generate electrons. An ion lens 115 is positioned downstream of the gate electrode 116. The electrons can enter the ion reaction device via an opening 115a provided in the ion lens 115. In some embodiments, the electrons can be employed to cause fragmentation of ions in the vicinity of the trap center via electron activation dissociation, as discussed in more detail below.

In addition, the ion reaction device 100 includes a T-shaped electrode 119 (which is herein also referred to as an isolation electrode) that extends along the central axis (CA) from the proximal end of the ion reaction device to its distal end and can be used, as discussed in more detail below, to cause fragment ions generated in the vicinity of the center of the ion reaction device into at least one of the branches 111/113.

An RF voltage source 200 operating under the control of a controller 201 applies RF voltages to the quadrupole rods 105/107 to radially confine the precursor and ion fragments in the vicinity of the central axis (CA) and the transverse axis (TA) of the ion reaction device 100. In particular, the polarities of the RF signals applied to the first and the second set of electrodes 105/107 are selected such that the generated quadrupolar field can confine the ions (precursor and fragment ions) in the vicinity of the central axis (CA) and the transverse axis (TA). In some embodiments, the frequency of the applied RF signals can be, for example, in a range of about 0.2 MHz to about 2 MHz and the amplitude of the applied RF signals can be, for example, in a range of about 0 V to about 600 V.

Two DC voltage sources 300 and 302 apply dc voltages to the two sets of the quadrupole rods 105/107 such that the dc voltages applied to any two rods of the two sets that are positioned diagonally relative to one another have the same sign and the dc voltages applied to any two rods facing one another have opposite signs. For example, with continued reference to FIGS. 1A and 1B, in this embodiment, the voltage source 300 applies a positive dc voltage to the L-shaped rods 105a/107a and the voltage source 302 applies a negative dc voltage to the L-shaped rods 105b/107b.

A DC voltage source 303 operating under the control of the controller 201 applies a DC voltage to the T-shaped electrode 119. As discussed in more detail below, the controller 201 can control the dc voltage applied to the T-shaped electrode 119 so as to trap fragment ions generated via fragmentation of a plurality of precursor ions in the one or both of the branches 111/113 or to release the trapped fragment ions so that they can undergo another fragmentation in the vicinity of the trap center.

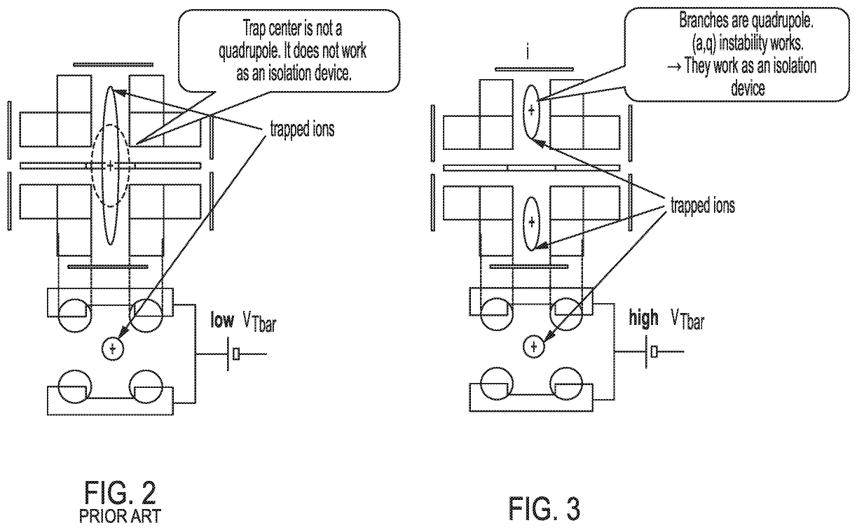

An ion reaction device according to the present teachings can advantageously allow isolating the initially formed fragment ions and subject those fragment ions to another fragmentation. By way of illustration, FIG. 2 schematically depicts an ECD ion reaction device, where ion fragments can be formed in the vicinity of the trap center. As the electromagnetic field at the trap center is not quadrupolar (the field at the trap center is influenced by 8 rods), it is not feasible to isolate the ion fragments and select and release them based on their m/z ratios.

In contrast, the electromagnetic field within the transverse branches of the depicted ECD ion reaction device is quadrupolar as it is generated by the four side rods. Thus, the ion fragments can be isolated in these branches based on their mass by inducing mass-dependent instability, as discussed in more detail below.

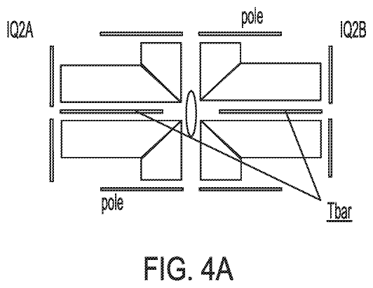

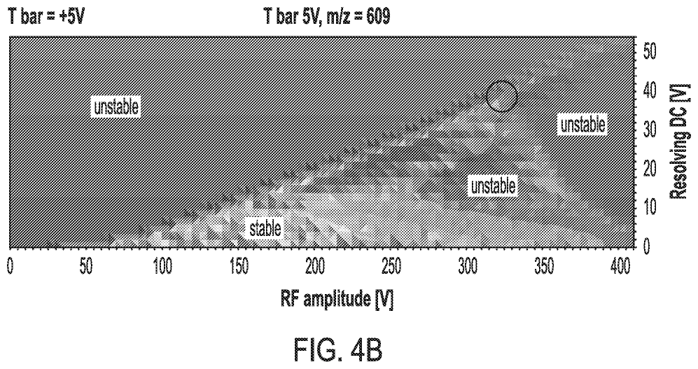

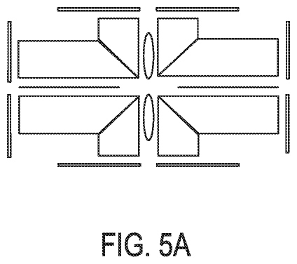

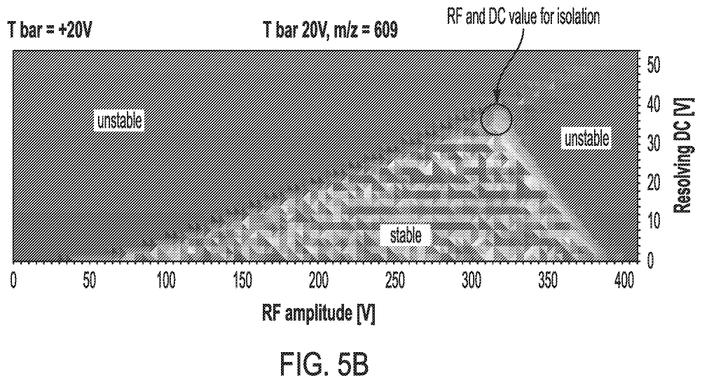

By way of further illustration, FIG. 4A shows an ion reaction device according to the present teachings, such as the aforementioned ion reaction device 100 in which a DC voltage of 5 volts is applied to the T-shaped electrode for causing ions at the center to be introduced to one or both transverse branches. Simulation results show that an applied voltage of 5 volts is not particularly effective in achieving isolation of the fragment ions within the transverse branches. FIG. 4B shows regions of stability and instability of an ion having m/z=609 as a function of amplitude of an RF signal and a resolving DC voltage applied to the rods, indicating the difficulty in isolating such an ion with a voltage of 5 volts applied to the T-shaped electrode. In contrast, with reference to FIGS. 5A and 5B, the application of a 20-volt DC voltage to the T-shaped electrode can result in some combinations of RF signal amplitude and DC resolving voltage that can lead to stably isolating the ion in the transverse branches.

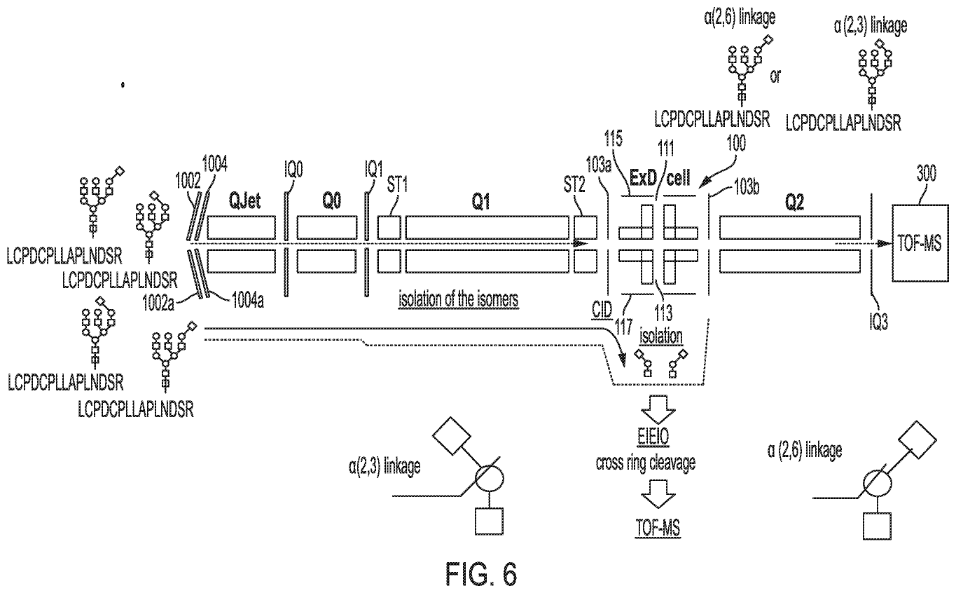

An ion reaction device according to the present teachings can be employed in a variety of mass spectrometers. By way of example, FIG. 6 schematically depicts a mass spectrometer 1000 according to an embodiment in which the above ion reaction device 100 is incorporated. Without loss of generality and only for illustrative purposes, FIG. 6 is discussed in connection with the use of the mass spectrometer 1000 for sugar linkage analysis of glycopeptides.

The mass spectrometer 1000 includes a curtain plate 1002 and an orifice plate 1004 having apertures 1002a/1004a through which ions generated by an upstream ion source (not shown) are received. A variety of ion sources can be employed. Some examples of suitable ion sources can include, without limitation, an electrospray ionization device, a nebulizer assisted electrospray device, a chemical ionization device, a nebulizer assisted atomization device, a chemical ionization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, among others.

An ion optic QJet comprising four rods arranged in a quadrupole configuration forms an ion beam for transmission to downstream components of the mass spectrometer. An ion lens IQ0 separates the QJet region from an ion guide Q0, which is also formed by a quadrupolar arrangement of four rods. The ion guide Q0 can focus the ions via a combination of gas dynamics and RF voltages applied to its rods. An ion lens IQ1 and a quadrupole stubby lens ST1 can focus the ions as they pass from the Q0 ion guide into Q1 mass filter. In this embodiment, the Q1 can function as a mass analyzer to allow the selection of ions with a selected m/z ratio (or a range of m/z ratios) for passage to the reaction ion device 100 via passage through the stubby ST2 and the entrance electrode 103a.

The ions exiting the ion reaction device 100 pass through the exit electrode 103b to reach an ion guide Q2, which is formed by a quadrupolar arrangement of four rods. The Q2 can function as a CID dissociation device and/or an ion guide to introduce ions into a downstream time-of-flight (TOF) mass analyzer. The ions can exit the Q2 ion guide via an ion lens IQ3 to reach a downstream mass analyzer, such as a time-of-flight (ToF) mass analyzer.

In use, a plurality of precursor ions isolated by Q1 can be introduced into the ion reaction device via an input port thereof. The precursor ions can undergo fragmentation in the vicinity of the trap center to generate a plurality of fragment ions (which are herein referred to as first fragment ions to distinguish them from fragment ions generated via a subsequent fragmentation of the first fragment ions, as discussed in more detail below). In some embodiments, the fragmentation of the precursor ions in the trap center can be achieved via collision induced dissociation (CID). In other embodiments, the fragmentation of the precursor ions (or at least a portion thereof) can be achieved via electron activation dissociation (EAD). For example, in this embodiment, the filament 118 disposed in proximity of the gate electrode 116 that is positioned at the distal end of the transverse branch 111 generates electrons that enter the trap center via passage through the transverse branch 111 to cause at least a portion of the precursor ions to undergo electron activation dissociation (EAD) to generate the first plurality of fragment ions.

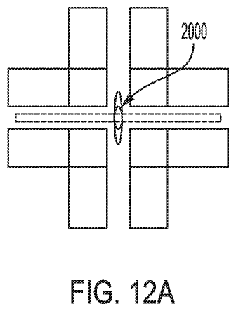

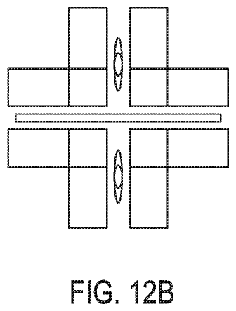

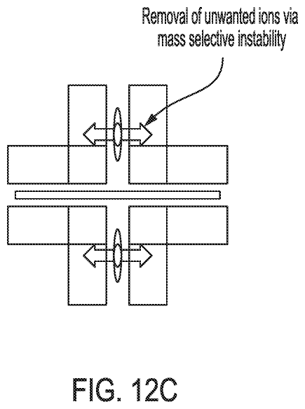

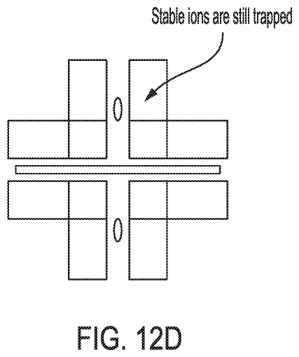

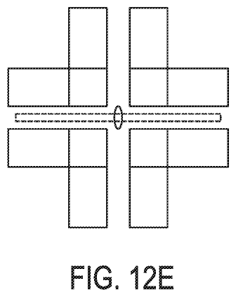

FIG. 12A schematically shows a plurality of fragment ions 2000, including some that are unwanted (shown in gray in this figure) in the center of the RF trap.

With reference to FIG. 12B, the application of a suitable DC voltage to the T-shaped electrode 119 can cause the fragment ions 2000 (or at least a portion thereof) to enter one or both of the transverse branches of the ion reaction device 100.

With reference to FIG. 12C, following the introduction of the first fragments ions into one or both transverse branches of the ion reaction device 100, the voltage source 200 can be activated to apply a resolving dc voltage to the ions isolated in those transverse branches so as to remove unwanted fragment ions, e.g., unwanted ions with m/z ratios outside of a predefined m/z range including the target ions, as shown by the arrows using mass-induced instability. As shown in FIG. 12D, the remaining ions (i.e., target ions) are still trapped within at least one or both branches. With reference to FIG. 12E, these ions can be released from the transverse branches and introduced into the trap center by lowering the DC voltage applied to the T-shaped electrode. The ions isolated in the branches by mass selective stability are released to the trap center independent of mass. Before releasing the target ions from the branches, resolving DC is set at zero.

The selected first fragment ions introduced into the trap center can undergo another fragmentation, e.g., via EAD, using the electrons generated by the above filament 118 so as to generate a second plurality of fragment ions. The second plurality of fragment ions can exit the ion reaction device and the ion guide Q2 to reach a downstream ToF analyzer, which can generate a mass spectrum of the second plurality of fragment ions.

In some embodiments, CID can be applied to the selected first fragment ions by applying CID activation DC voltage between the EAD device and Q2 when the selected first fragment ions are released from the EAD device.

As noted above, an ion reaction device according to the present teachings allows performing MS(n) mass spectrometry. By way of example, the following MS(3) workflows can be achieved using an ion reaction device according to the present teachings:
MS(3): isolation (1^{st} MS by Q1)→CID→isolation of CID product (2^{nd} MS)→CID→mass analysis (3^{rd} MS);
MS(3): isolation (1^{st} MS by Q1)→ECD→isolation of ECD (2^{nd} MS)→CID→mass analysis (3^{rd} MS);
MS(3): isolation (1^{st} MS by Q1)→CID→isolation of CID product (2^{nd} MS)→ECD→mass analysis (3^{rd} MS); and
MS(3): isolation (1^{st} MS by Q1)→ECD→isolation of ECD product (2^{nd} MS)→ECD→mass analysis (3^{rd} MS).
MS(4) workflow can also be achieved using an ion reaction device according to the present teachings. For example, the following MS(4) workflow can be achieved:
MS(4): isolation (1^{st} MS by Q1)→CID→isolation of CID product (2^{nd} MS)→ECD→isolation of ECD product (3^{rd} MS)→CID→mass analysis (4^{th} MS).

The following example is provided for further elucidation of various aspects of the present teachings and is not intended to necessarily indicate the optimal ways of practicing the invention or optimal results that can be obtained.

### EXAMPLE

A mass spectrometer similar to that shown in FIG. 6 was employed to obtain the data described in this section. A pair of isomeric glycopeptides having the structures shown in FIGS. 8A and 8B with different sialic acid linkages (alpha(2,3) and alpha (2,6)) were used as samples. Sialic acid is represented using a diamond, and the linkage is differentiated via the direction of the linkage between the sialic acid (diamond) and hexose (circle). The purpose of the workflow in this example was to distinguish the two linkages in an intact glycopeptide. In natural samples, such as digested proteins, the two linkages are mixed.

A mixed isomeric sample with the two glycopeptides with different sialic acid linkages were separated using liquid chromatography (LC). Although such separation can be achieved by LC, it is not possible to identify the types of sialic acid linkages using LC.

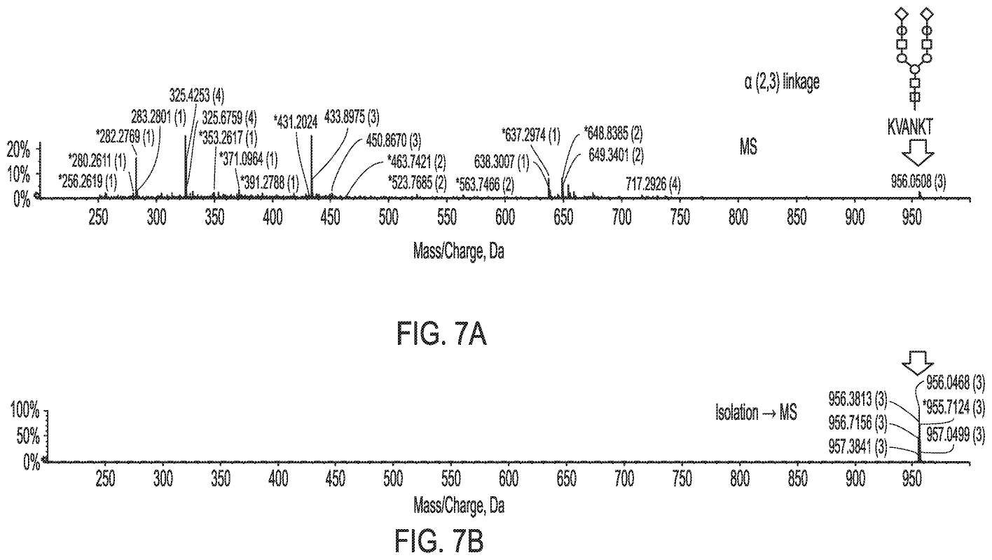

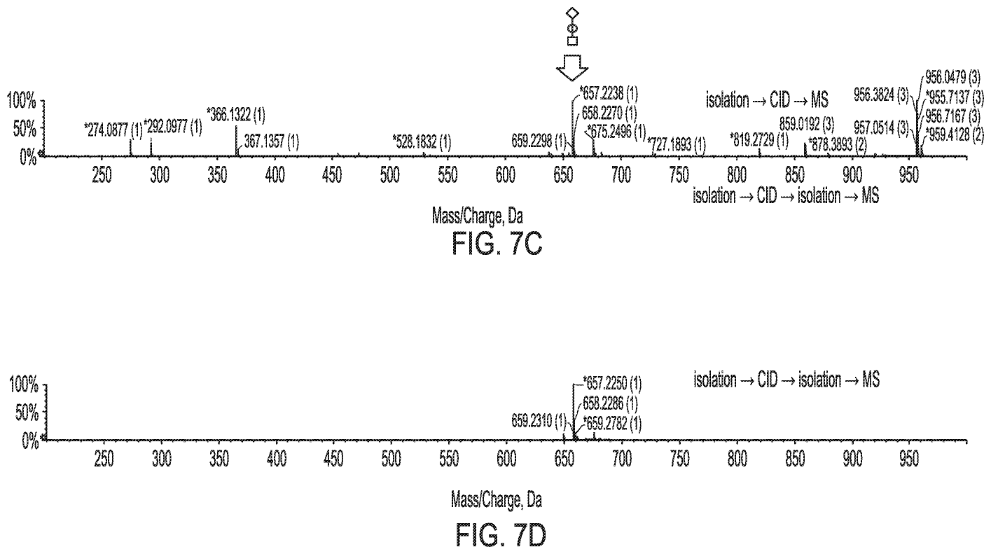

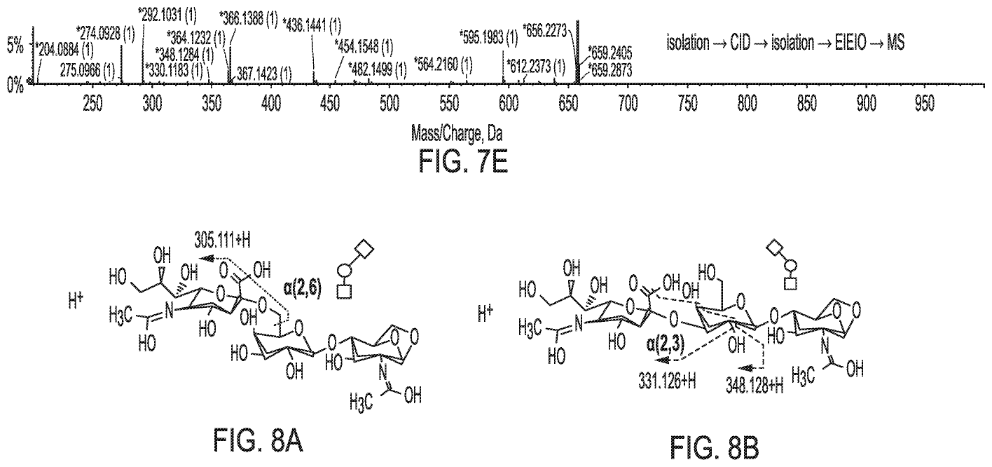

The separated glycopeptides were ionized using electrospray ionization (ESI). FIG. 7A shows the resultant mass spectrum.

The ions generated by ESI were introduced into the mass spectrometer through curtain plate 1002 and orifice plate 2004 and were further introduced into Q1 via QJet, IO0, Q0, IQ1 and ST1. The target glycopeptides with the specific m/z ratios were isolated from impurities by the Q1 filter. FIG. 7B shows the mass spectrum of the isolated glycopeptides without any dissociation.

The isolated glycopeptides were introduced into the EAD reaction device through ST2 and lens electrode 103a. In this example, the first mode of dissociation was via CID. To induce collisional dissociation, a DC bias between the EAD reaction device 100 and the QJet was set at a high value, typically QJet bias is set at +30 V greater than the EAD reaction device 100. FIG. 7C shows the mass spectrum of the CID products of the isolated glycopeptides. Because CID operates on the glycan in the glycopeptides, the fragments were related to glycan fragments.

To survey the sialic acid linkage, the glycan fragments with m/z of 557 (see FIG. 7C) with one of the linkages shown in FIGS. 8A or 8B were selected. For a second dissociation to survey its sialic acid linkage, the fragment with m/z of 557 was isolated using the methods described herein. The entire CID products were stored in the electron beam branch by applying a voltage of +20V (or isolation voltage) to the T-shaped electrode. A predetermined resolving DC voltage and trapping RF signal with a predefined amplitude were applied to isolate m/z of 557. The resolving DC and the trapping RF amplitude were set to the regular condition, and the isolated CID fragments with m/z of 557 were released into the center of the EAD reaction device 100 by setting the voltage applied to the T-shaped electrode at the regular value. FIG. 7D shows a mass spectrum of the isolated CID fragments.

In this example, the second dissociation was achieved via Electron Impact Excitation of ions from Organics (EIEIO). An electron beam with a kinetic energy of 10 eV was applied to the isolated fragments with m/z of 557. EIEIO is a type of electron activation dissociation that can be applied to singly charged ions. In case of glycans, EIEIO induces cross ring cleavage, which can distinguish the sialic acid linkage (See, FIG. 6). As shown in FIG. 7E, fragments by MS(3) workflow obtained via CID and EIEIO were observed.

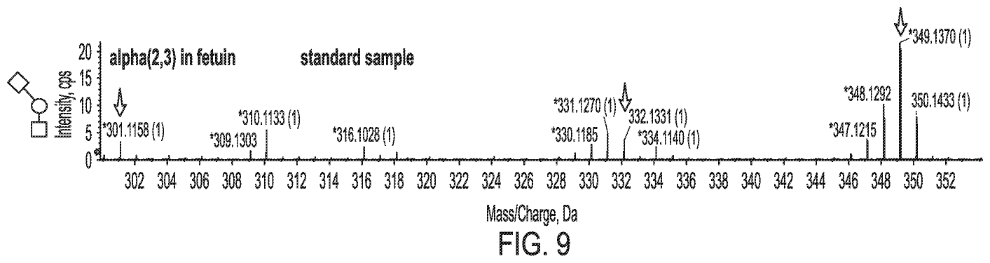

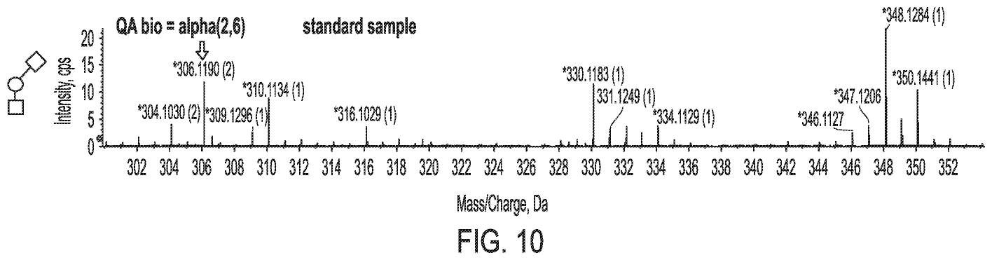

FIG. 9 shows a CID-EIEIO spectrum of a standard that is verified to have alpha (2,3) linkage in tryptic digest of a protein, fetuin from bovine. FIG. 10 shows another CID-EIEO spectrum of a standard that is verified to have alpha (2,6) linkage. By comparison between the two standard spectra, m/z of diagnostic peaks were obtained. For alpha(2,3) linkage diagnostic (FIG. 8B), two peaks with m/z of 331.126+H and 348.128+H were discovered. For alpha(2,6) linkage diagnostic (FIG. 8A), a peak with m/z of 305.111+H was discovered.

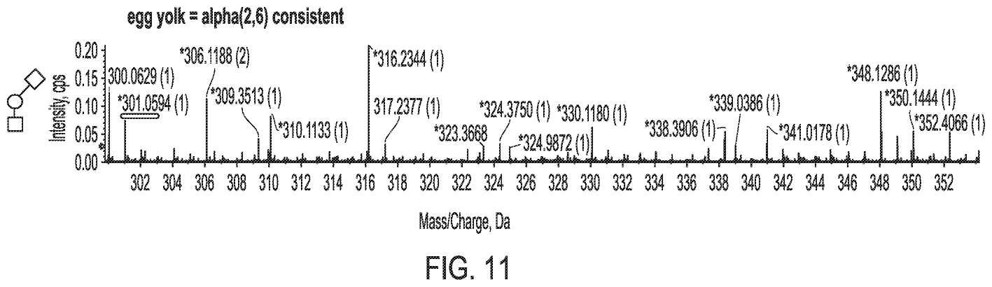

FIG. 11 is a demonstration of identification of an unknown linkage of sialic acid in a glycopeptide contained in hen's egg yolk. The same workflow (CID, then EIEIO) described above was applied. The spectrum appearance is similar to that of the standard with the diagnostic peaks associated with alpha(2,6) linkage. Thus, it can be concluded that the glycopeptides in egg yolk have sialic acid linkages as alpha (2,6).

Those having ordinary skill in the art will appreciate that various changes can be made to the above embodiments without departing from the scope of the invention, as defined by the following claims.

1. A method of performing mass spectrometry, comprising:
ionizing a sample to generate a plurality of precursor ions,
passing said precursor ions through a mass filter to select at least one subset of said ions,
introducing said selected ions into a branched radiofrequency (RF) ion trap and subjecting at least a portion of said selected precursor ions to fragmentation within said ion trap so as to generate a first plurality of fragment ions,
isolating at least a portion of said first plurality of fragment ions,
releasing at least a portion of said isolated ions and subjecting at least a portion thereof to fragmentation so as to generate a second plurality of fragment ions.

2. The method of claim 1, wherein said branched RF ion trap comprises an axial section characterized by a central axis and having a trap center and four branches extending from the trap center.

3. The method of claim 2, wherein two of said branches are positioned transverse to said central axis.

4. The method of claim 3, wherein said step of isolating at least a portion of said first plurality of fragment ions comprises causing said at least a portion of said first plurality of fragment ions to enter at least one of said transverse branches.

5. The method of claim 4, wherein said step of causing said at least a portion of said first plurality of fragment ions to enter one of said transverse branches comprises applying a DC voltage to an isolation electrode positioned in proximity of said branches.

6. The method of claim 5, wherein said isolation electrode extends from said proximal end to said distal end of the axial section.

7. The method of claim 5, further comprising removing unwanted fragment ions from the fragment ions in said at least one transverse branch by applying a resolving DC voltage to said at least one transverse branch.

8. The method of claim 7, wherein said step of releasing said selected isolated ions comprises adjusting a DC voltage applied to said isolation electrode.

9. The method of claim 8, wherein said released ions undergo said second fragmentation in vicinity of said trap center.

10. The method of claim 1, wherein any of said precursor ions and said first plurality of fragment ions are dissociated via electron activation dissociation using an electron beam having an energy in a range of about 0 eV to about 50 eV.

11. The method of claim 10, further comprising passing said second plurality of fragment ions through a mass analyzer so as to generate a mass spectrum thereof.

12. The method of claim 11, wherein said mass analyzer comprises a time-of-flight mass analyzer.

13. The method of claim 1, wherein said precursor ions are fragmented using any of collision induced dissociation (CID) and electron activation dissociation (EAD).

14. The method of claim 13, wherein said first plurality of fragment ions are fragmented using any of CID and EAD.

15. A mass spectrometer, comprising:
an ion reaction device, comprising:
a branched radiofrequency (RF) ion trap comprising eight L-shaped rods positioned axially at a distance relative to one another so as to provide an axial section characterized by a central axis for receiving ions from an ion source and two branched sections extending transversely from a central portion of said axial section and characterized by a transverse axis for receiving electrons from an electron source,
a source for generating electrons such that the electrons enter said ion reaction device along said transverse axis to interact with ions received along said central axis in vicinity of said central portion of said axial section so as to cause fragmentation of at least a portion of said ions to generate a first set of fragment ions,
an isolation electrode positioned in vicinity of said branched sections for causing transfer of at least a portion of said first set of fragment ions from the central portion to at least one of said branched sections and isolating the ions transferred to said at least one of said branched sections,
a DC voltage source for applying a DC voltage to at least one of said L-shaped rods for inducing mass selective instability for at least a portion of said first set of fragment ions isolated in said at least one branched section so as to remove unwanted ions from said first set of fragment ions.

16. The mass spectrometer of claim 15, further comprising an electron source positioned to provide a beam of electrons along said transverse axis.

17. The mass spectrometer of claim 16, further comprising a device for generating a magnetic field parallel to said transverse axis.

18. The mass spectrometer of claim 15, further comprising another DC voltage source for applying a DC voltage to said isolation electrode to cause transfer of said at least a portion of said first set of ion fragments into said at least one of the branched sections.

19. The mass spectrometer of claim 15, further comprising an RF voltage source for applying an RF voltage to at least one of said L-shaped rods for radially confining said precursor ions and said ion fragments.

20. The mass spectrometer of claim 15, further comprising a mass analyzer disposed downstream of said ion reaction device to receive ions from said ion reaction device and generate a mass spectrum thereof.

21. (canceled)
